(19) United States
(12) Patent Application Publication
(10) Pub. No.: US 2010/0141149 A1
(43) Pub. Date: Jun. 10, 2010

(54) FAULT PROTECTION METHODS AND APPARATUS FOR COLD CATHODE FLUORESCENT LAMPS

(76) Inventors: Bairen Liu, Hangzhou (CN); Lei Du, Hangzhou (CN); Yuancheng Ren, Hangzhou (CN)

Correspondence Address: PERKINS COIE LLP;PATENT-SEA, P.O. BOX 1247, SEATTLE, WA, 98111-1247, US

(21) Appl. No.: 12/634,005

(22) Filed: Dec. 9, 2009

(30) Foreign Application Priority Data
Dec. 9, 2008 (CN) 200810147795.3

(51) Int. Cl. H05B 41/00

(52) U.S. Cl. 315/120

(57) ABSTRACT

The present disclosure provides methods and apparatus for fault protection for electronic devices (e.g., cold cathode fluorescent lamps). In one embodiment, a fault signal is detected and compared with a threshold to output a comparison signal. The comparison signal is then processed to generate a trigger signal, which triggers a fault control block once it satisfies certain fault conditions.

### CROSS-REFERENCE TO RELATED APPLICATION(S)

This application claims priority to Chinese Application No. 200810147795.3, filed on Dec. 9, 2008, the disclosure of which is incorporated herein by reference in its entirety.

### TECHNICAL FIELD

The present disclosure relates to fault protection methods and apparatus for electronic devices, and in particular, for driving circuits of cold cathode fluorescent lamps.

### BACKGROUND

During normal operation, a cold cathode fluorescent lamp (CCFL) inverter regulates the current flowing through the lamp (the lamp current) to control the lamp luminance. In open lamp conditions or during an ignition process, the CCFL inverter regulates the voltage across the lamp (the lamp voltage) to protect devices (e.g., transformers, switching circuits, etc.). Further, short circuit protection circuitry and open circuit protection circuitry are also indispensable in the CCFL.

Typically, the lamp current and the lamp voltage are detected for regulation and protection control. In multiple-lamp applications, signals such as the maximum lamp voltage, the minimum lamp voltage, the minimum lamp current, the maximum lamp voltage difference, and the maximum lamp current difference (collectively referred to as “fault signals” hereinafter) are used as open circuit or short circuit indication signals. However, different fault signals need to be processed by different protection circuits, resulting in design complexity and high cost.

Power stage circuit topologies and feedback techniques used in multi-lamp applications also lead to the requirement of different protection circuits. In addition, pulse dimming is necessary in most applications and the fault signals must not be affected by the pulse dimming. In order to eliminate the pulse dimming interference, a large RC combination is often utilized. However, the addition of such a large RC combination may slow the response of the protection circuits and reduce the difference in a fault signal between the normal operation and the fault conditions.

### BRIEF DESCRIPTION OF THE DRAWINGS

FIG. 1 illustrates a fault signal sampling and detecting circuit according to embodiments of the present disclosure;

FIG. 2 illustrates a graph of a fault signal under normal operation and under a fault condition in the circuit of FIG. 1 according to embodiments of the present disclosure.

FIG. 3 illustrates another fault signal sampling and detecting circuit according to embodiments of the present disclosure.

FIG. 4 illustrates a graph of a fault signal under normal operation and under a fault condition in the circuit of FIG. 3 according to embodiments of the present disclosure.

FIG. 5 illustrates a block diagram of a protection circuit with a negative logic fault signal according to embodiments of the present disclosure.

FIG. 6 illustrates a graph of operating waveform of the protection circuit in FIG. 5 under normal operation according to embodiments of the present disclosure.

FIG. 7 illustrates a graph of operating waveform under a fault condition of the protection circuit in FIG. 5 according to embodiments of the present disclosure.

FIG. 8 illustrates a block diagram of a protection circuit with a negative logic fault signal used as a current regulating signal according to embodiments of the present disclosure.

FIG. 9 illustrates a positive logic fault signal sampling and detecting circuit according to embodiments of the present disclosure.

FIG. 10 illustrates a comparison diagram of the positive logic fault signal sampling and detecting circuit in FIG. 9 under normal operation and under a fault condition according to embodiments of the present disclosure.

FIG. 11 illustrates a block diagram of a protection circuit with a positive logic fault signal according to embodiments of the present disclosure.

FIG. 12 illustrates a graph of operating waveform of the protection circuit in FIG. 11 under normal operation according to embodiments of the present disclosure.

FIG. 13 illustrates a graph of operating waveform of the protection circuit in FIG. 11 under fault condition according to embodiments of the present disclosure.

FIG. 14 illustrates a block diagram of a protection circuit with a positive logic fault signal used as a voltage regulating signal according to embodiments of the present disclosure.

FIG. 15 illustrates a block diagram of a protection circuit using both a positive logic and a negative logic fault signal according to embodiments of the present disclosure.

FIG. 16 illustrates a block diagram of a protection circuit using both a positive logic and a negative logic fault signal for fault protection control and for current and voltage regulation according to embodiments of the present disclosure.

### DETAILED DESCRIPTION

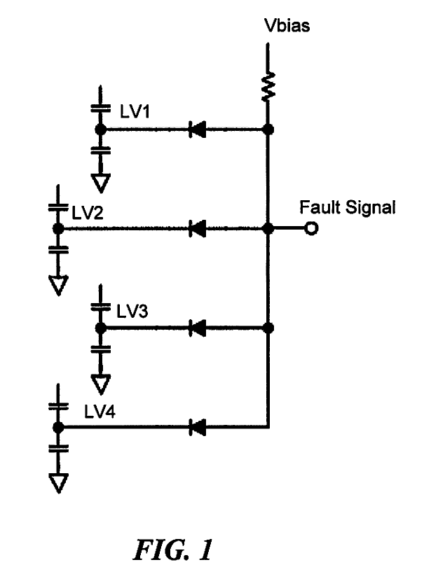

This disclosure describes embodiments of fault protection methods and apparatus for electronic devices (e.g., CCFL). Several of the details set forth below (e.g., example circuits and example values for these circuit components) are provided to describe the following embodiments and methods in a manner sufficient to enable a person skilled in the relevant art to practice, make, and use them. Several of the details and advantages described below, however, may not be necessary to practice certain embodiments and methods of the technology. A person of ordinary skill in the relevant art, therefore, will understand that the technology may have other embodiments with additional elements, and/or may have other embodiments without several of the features shown and described below with reference to FIGS. 1-16.

As used herein, a fault signal refers to a signal that may indicate the working conditions of an electronic device (e.g., a CCFL). For example, the fault signal may indicate whether a CCFL is under normal operation, an open circuit condition, or a short circuit condition. Fault signals may be divided into two classes: positive logic fault signals and negative logic fault signals. A positive logic fault signal refers to a signal that has a larger value in fault conditions than in normal operation. For example, the maximum lamp voltage difference, the maximum lamp current difference, and the maximum lamp voltage are positive fault signals. A negative logic fault signal refers to a signal that has a smaller value in fault conditions than in normal operation. For example, the minimum lamp voltage, the minimum lamp current, and the mean lamp current are negative logic fault signals.

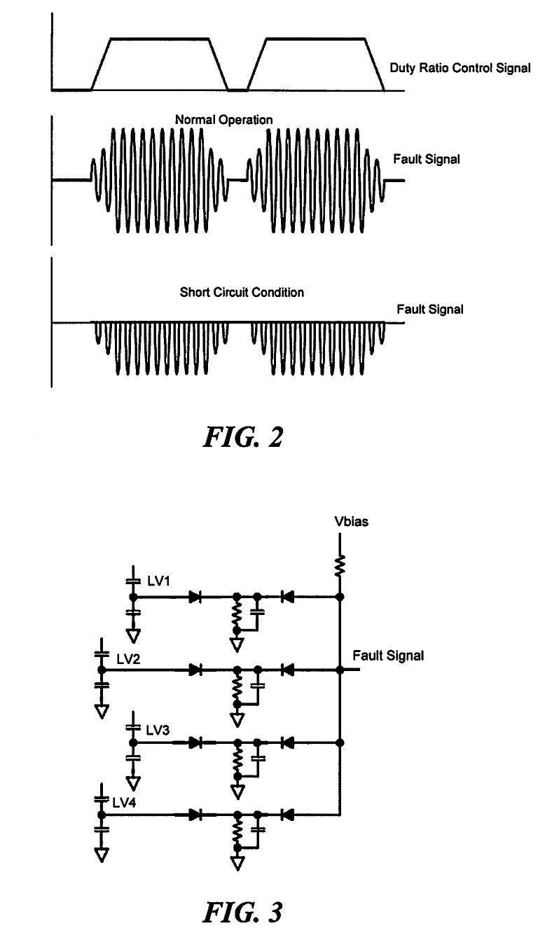

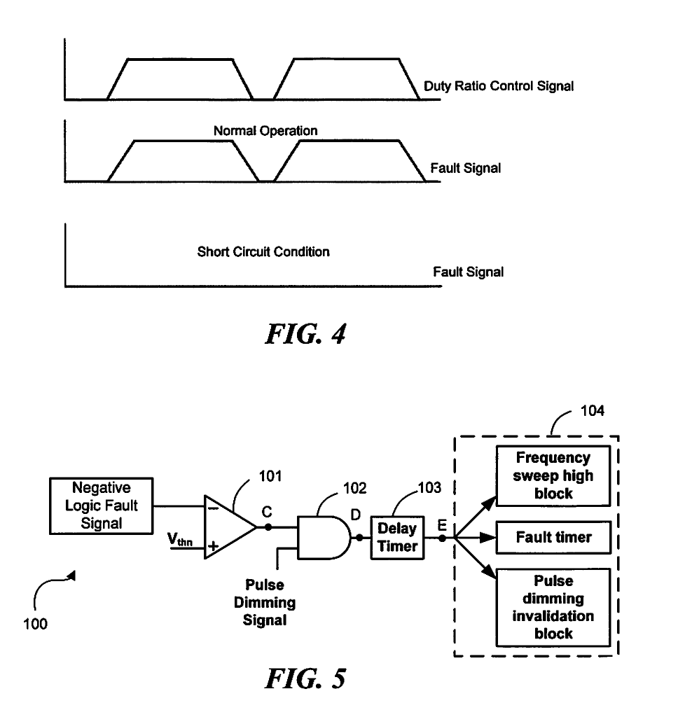

FIG. 1 and FIG. 3 illustrate negative logic fault signal sampling and detecting circuits according to embodiments of the present disclosure. In these embodiments, the minimum lamp voltage is used as an example of a negative logic fault signal. The circuit illustrated in FIG. 1 samples and detects the minimum lamp voltage in multi-lamp application in which the lamp voltages are in-phase. The circuit illustrated in FIG. 3 samples and detects the minimum lamp voltage in multi-lamp application in which the lamp voltages are in reversed-phase. Both the circuits illustrated in FIG. 1 and in FIG. 3 are in “AND” logic configuration for the minimum lamp voltage detection. FIG. 2 and FIG. 4 illustrate graphs of the negative logic fault signal in normal operation and in short circuit condition of the circuits illustrated in FIG. 1 and FIG. 3, respectively. As shown in FIG. 2 and FIG. 4, in short circuit condition (a fault condition), the negative logic fault signal is smaller than in normal operation.

FIG. 5 illustrates a block diagram of a protection circuit 100 in using a negative logic fault signal according to embodiments of the present disclosure. In the illustrated embodiment, the protection circuit 100 includes a comparator 101, an “AND” gate 102, a delay timer 103, and a fault control block 104. The fault control block 104 comprises a frequency sweep high block, a fault timer, and a pulse dimming invalidation block. An inverting input of the comparator 101 is coupled to a detected negative logic fault signal, and a non-inverting input of the comparator 101 is coupled to a threshold voltage. The output of the comparator 101 is coupled to an input of the “AND” gate 102. Another input of the “AND” gate 102 is coupled to a pulse dimming signal, and the output of the “AND” gate 102 is coupled to the input of the delay timer 103. The output of the delay timer 103 is coupled to the fault control block 104.

As used herein, a pulse dimming signal is considered to be at a high level during a dimming-on period and at a low level during a dimming-off period for illustration purposes. The invalidation of a pulse dimming signal refers to forcing the pulse dimming signal to be at a high level. Further, the terms “pulse dimming mode” and “non-pulse dimming mode” respectively correspond to when a pulse dimming signal is in pulsed form and when a pulse dimming signal is at a high or low level. In various examples provided in this disclosure, a pulse dimming signal is at a high level in non-pulse dimming mode. However, in other embodiments, many alternatives, modifications, and variations of the logic value assigned to the pulse dimming signal may also be used.

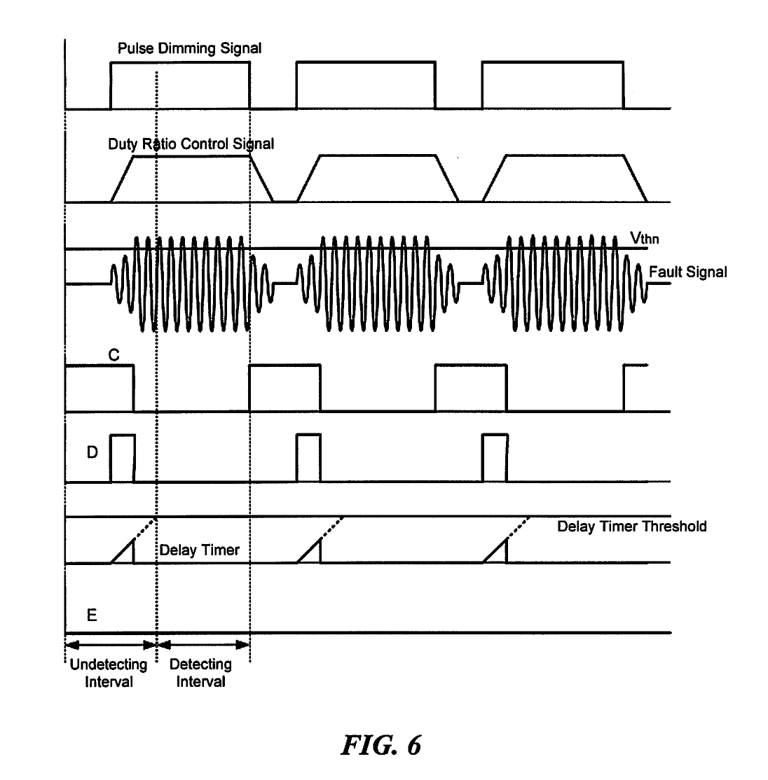

FIG. 6 illustrates a graph of operating waveform in normal operation of the circuit in FIG. 5. As shown in FIG. 6, in normal operation, the negative logic fault signal detected is higher than the threshold voltage except when the circuit is working in pulse dimming mode and the pulse dimming signal is in dimming off period or the duty ratio control signal is in its soft-start or soft-shutdown stage. In pulse dimming mode, when the dimming signal is in dimming off period, there is no lamp voltage or lamp current. When the dimming signal changes from a dimming off period to a dimming on period or reversely, to eliminate voltage and current overshoots, the duty ratio control signal experiences a soft-start or soft-shutdown stage respectively during which the lamp current or the lamp voltage remains below the desired steady state values. Thus, in pulse dimming mode, when the dimming signal is in dimming off period or the duty ratio control signal is in its soft-start or soft-shutdown stage, the detected negative logic fault signal is lower than the threshold voltage, the comparator 101 thus outputs a comparison signal in high level at node C. When the soft-start stage is finished and the detected negative logic fault signal is higher than the threshold voltage, the comparison signal at node C is low. Thus, in normal operation, the comparison signal is a series of pulse signals when the circuit works in dimming mode, and it is a low level signal when the circuit does not work in dimming mode.

The “AND” gate 102 receives the comparison signal and the pulse dimming signal, and generates at the output node D a control signal. As illustrated in FIG. 6, in normal operation, if the circuit works in dimming mode, the control signal is a narrow pulse signal with its pulse width similar to that of the soft-start or soft-shutdown signal of the duty ratio control signal. However, if the circuit is not in dimming mode, the control signal is at a low level.

The delay timer 103 receives the control signal, compares it with a predetermined threshold, and outputs a trigger signal at node E. If the pulse width of the control signal is larger than the predetermined threshold, the trigger signal is high, or else the trigger signal is low. Since the pulse width of the control signal in dimming mode can not reach the predetermined threshold of the delay timer 103, a low level trigger signal is output at node E. Therefore, in normal operation, the trigger signal generated from the delay timer 103 is at low level, even if the negative logic fault signal is lower than the threshold voltage during the dimming off period of the pulse dimming signal and during the soft-start stage of the duty ratio control signal. The fault control block 104 receives the trigger signal, it stays inoperative when the trigger signal is low until when the trigger signal changes to high, at which point the fault control block 104 is triggered. Thus, in normal operation, the fault control block 104 is un-triggered and stays inoperative.

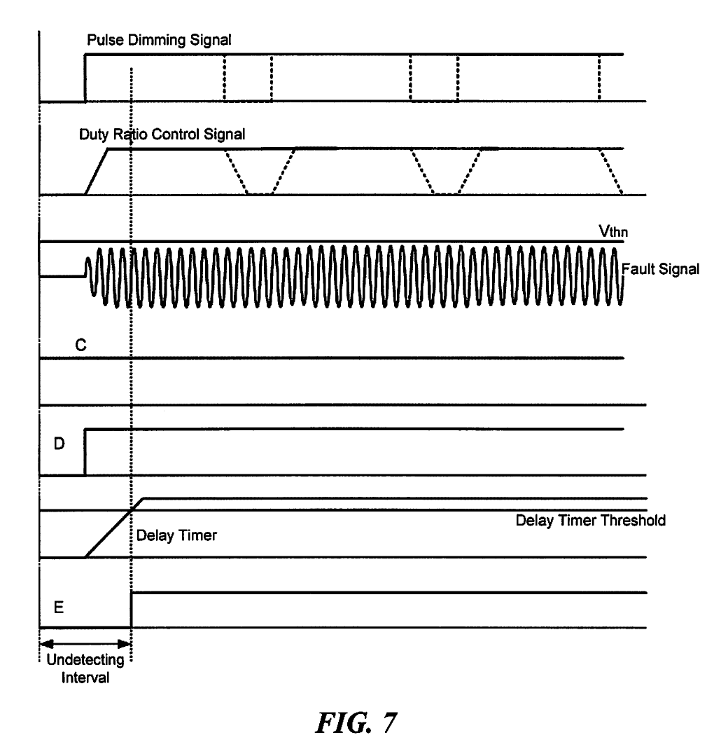

FIG. 7 illustrates a graph of operating waveform in fault condition of the circuit shown in FIG. 5. Once a fault condition such as an open lamp condition occurs, the detected negative logic fault signal is lower than the threshold voltage. In this case, the comparison signal at node C is high. If the circuit does not work in dimming mode, the control signal at node D is high. If the circuit works in dimming mode, at the beginning of the first dimming on period of the pulse dimming signal, the control signal at node D changes to high and remains high with a duration that is at least that of the dimming on period of the pulse dimming signal. Such a control signal input to the delay timer 103 results in the predetermined threshold of the delay timer 103 being surpassed, and the trigger signal at node E is high. Thus, the fault control block 104 is triggered to function, e.g., the fault timer starts timing, and the frequency sweep high block starts to sweep the switching frequency to a higher value and the pulse dimming invalidation block forces the dimming signal to be invalid (i.e., the dimming signal is forced to remain high). Thereafter, when the accumulated time in the fault timer reaches a predetermined value and the trigger signal at node E has not yet been reset to low, the whole system is shut down.

Before the system is shut down, if a faulty CCFL is reignited by an augmented CCFL inverter output voltage resulted from sweeping high the switching frequency, the detected negative logic fault signal is higher than the threshold voltage except when the circuit is working in pulse dimming mode and the pulse dimming signal is in dimming off period and the duty ratio control signal is in its soft-start or soft-shutdown stage. In this case, the comparison signal at node C restores to a low level signal when the circuit is in non-pulse dimming mode or to a series of pulse signals when the circuit is in pulse dimming mode. Consequently, the control signal at node D restores respectively to a low level signal or to a narrow pulse signal when the circuit is in non-pulse dimming mode or in pulse dimming mode. The pulse width of the narrow pulse signal is generally similar to that of the soft-start control signal and thus can not reach the predetermined threshold of the delay timer 103. Therefore the delay timer 103 outputs a low level trigger signal again, that resets the fault timer as well as the fault control block, and the whole system will restore to normal operation.

In various embodiments of the fault protection methods and apparatus for CCFL disclosed herein, a negative logic fault signal can also be the minimum lamp current. In this case, the working principle of the protection circuit is similar to that when the negative logic fault signal is the minimum lamp voltage. In other embodiments, the negative logic fault signal may also include other suitable signals.

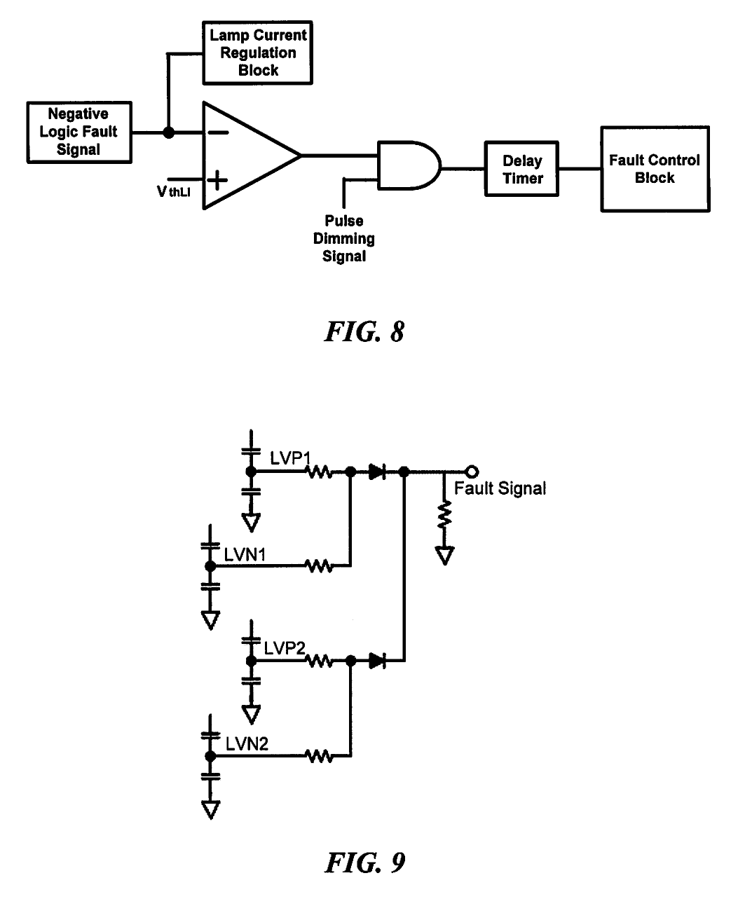

As shown in FIG. 8, a negative logic fault signal can be the mean lamp current according to embodiments of the disclosure. In this case, the negative logic fault signal can also operate as a lamp current regulating signal, i.e., this lamp current regulating signal is input to a lamp current regulation block to control the amount of current flowing through the lamp. In this instance, the negative logic fault signal can only be used to indicate the fault condition where all the lamps are open.

In the following description, embodiments with a positive logic fault signal operating as a fault signal as well as those with a positive logic fault signal in conjunction with a negative logic fault signal used for fault protection control is described. FIG. 9 illustrates a positive logic fault signal sampling and detecting circuit according to embodiments of the present disclosure. Using the maximum lamp voltage difference as an example of a positive logic fault signal, the circuit illustrated in FIG. 9 detects the maximum lamp voltage difference in multi-lamp applications where the lamp voltages are in reversed-phase by configuring in an “OR” logic configuration.

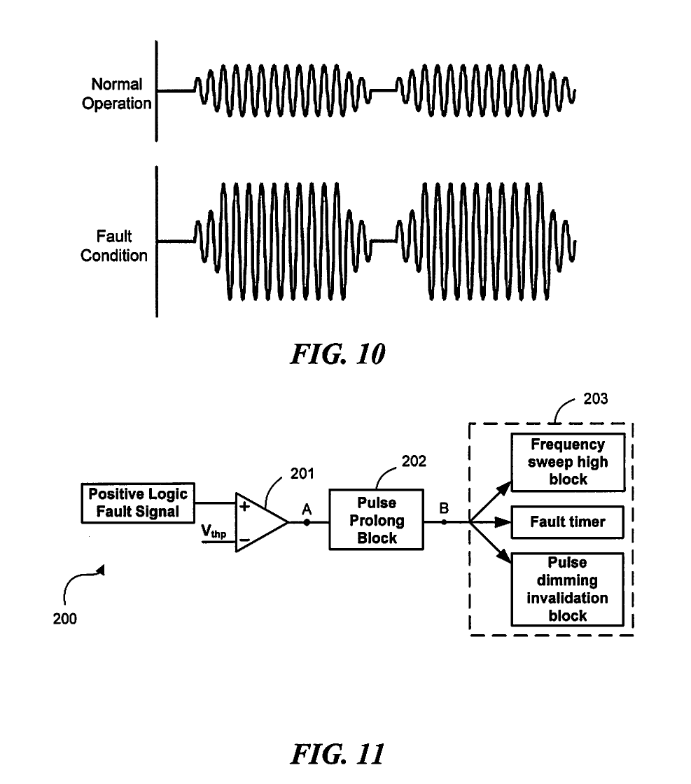

During normal operation, the differences among each lamp voltage are rather small. Once one of the lamps is open or short-circuited, its voltage is significantly changed resulting in a larger voltage difference between the faulty (open or short-circuited) lamp and the other lamps, as shown in FIG. 10.

FIG. 11 illustrates a block diagram of a protection circuit 200 in using a positive logic fault signal according to embodiments of the present disclosure. The protection circuit 200 comprises a comparator 201, a pulse prolong block 202, and a fault control block 203. The fault control block 203 comprises a frequency sweep high block, a fault timer, and a pulse dimming invalidation block. A non-inverting input of the comparator 201 is coupled to a detected positive logic fault signal, and an inverting input of the comparator 201 is coupled to a threshold voltage. The output of the comparator 201 is coupled to the fault control block 203 via the pulse prolong block 202.

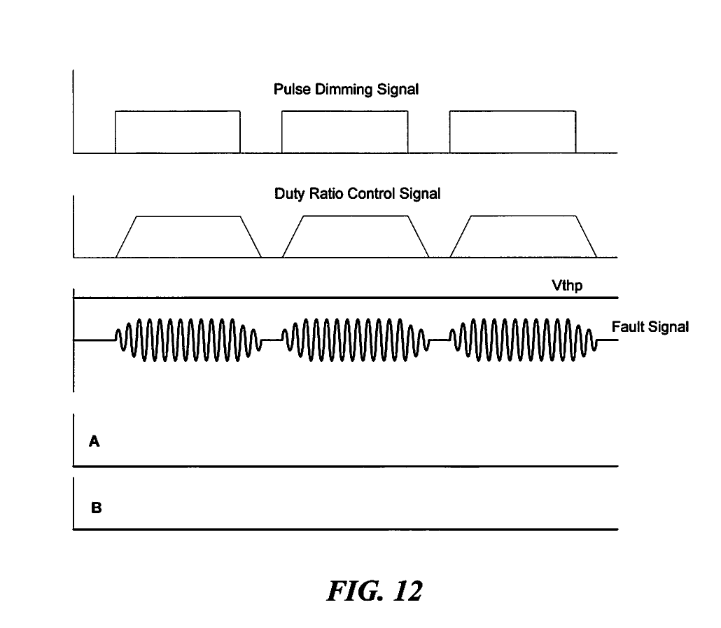

FIG. 12 illustrates a graph of operating waveform in normal operation of the circuit in FIG. 11. As shown in FIG. 12, the positive fault signal detected remains lower than a threshold voltage in normal operation. Comparator 201 compares the positive fault signal with the threshold voltage and outputs a comparison signal at node A, which is low in normal operation. Pulse prolong block 202 receives the comparison signal and prolongs the pulse period of the comparison signal for several pulse cycles to provide a trigger signal at node B. Since the comparison signal at node A is low in normal operation, the trigger signal at node B is also low. Fault control block 203 receives the trigger signal, it stays inoperative when the trigger signal is low until the trigger signal changes to high, at which time the fault control block 203 is triggered. Thus, in normal operation, the fault control block 103 is un-triggered and stays inoperative.

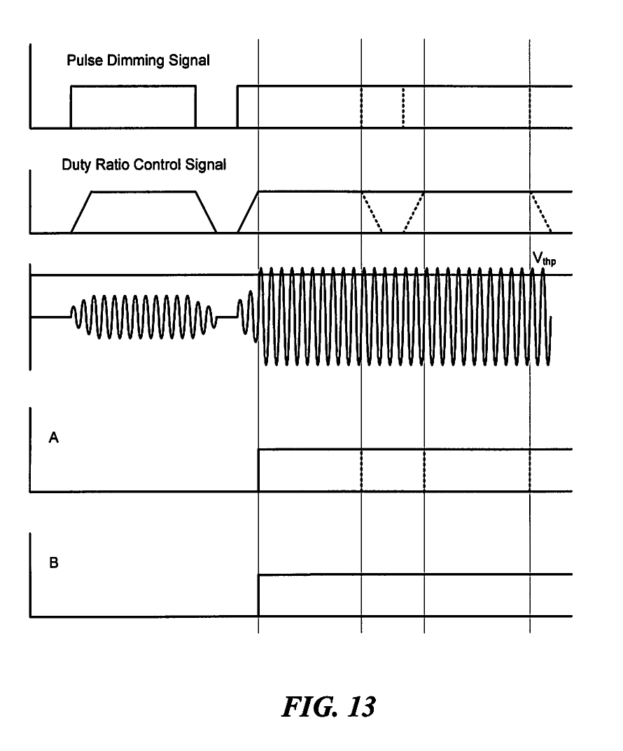

As shown in FIG. 13, once a fault condition such as an open lamp condition occurs, the detected positive logic fault signal is higher than the threshold voltage except when the circuit is working in pulse dimming mode and the pulse dimming signal is in dimming off period or the duty ratio control signal is in its soft-start or soft-shutdown stage. Thus, under a fault condition, the comparison signal at node A is a high level signal or a series of pulse signals when the circuit is in non-pulse dimming mode or in pulse dimming mode. Thus, the comparison signal, with its pulse period prolonged for several pulse cycles through the pulse prolong block 202, results in the trigger signal at node B to be high. Such a high level trigger signal represents the occurring of a fault condition and thus triggers the fault control block 203, i.e., the fault timer starts timing, the frequency sweep high block starts to sweep the switching frequency to a higher value, and the pulse dimming invalidation block forces the dimming signal to be invalid. When the fault timer has its accumulated time attained and the trigger signal at node B is still high, the whole system is shut down.

Because a pulse dimming signal is utilized to control the current to flow through the lamp from time to time, during the dimming off period of a pulse dimming signal, there is no lamp current and lamp voltage, resulting in the detected positive logic fault signal being lower than the threshold voltage. Therefore, if a system fault condition has occurred and the pulse dimming signal is still effective, a positive logic fault signal lower than the threshold voltage is detected during the dimming off period of the pulse dimming signal. In order to eliminate the pulse dimming signal interference, once a system fault condition is detected, the pulse dimming signal may be immediately invalidated, i.e., the pulse dimming signal may be kept in high level according embodiments of the present disclosure.

Before the system is shut down, if a faulty CCFL is reignited by an augmented CCFL inverter output voltage resulted from sweeping high the switching frequency, the detected positive logic fault signal restores to be lower than the threshold voltage. In this case, the comparison signal at node A restores to a low level, the trigger signal at node B consequently restores to a low level. Thus, the fault timer is reset as well as the fault control block, and the system returns to normal operation.

In various embodiments of the present disclosure, a positive logic fault signal can also include the maximum lamp current difference. In this case, the working principle of the protection circuit is similar to that when the positive logic fault signal is the maximum lamp voltage difference. In further embodiments, a positive logic fault signal can include other suitable signals.

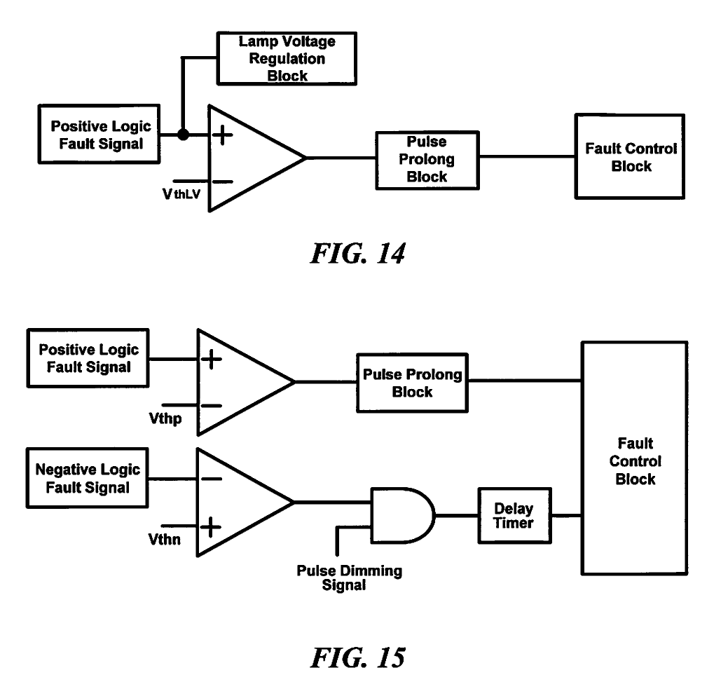

As shown in FIG. 14, a positive logic fault signal can also be the maximum lamp voltage according to embodiments of the present disclosure. In this case, the positive logic fault signal can also be used as an open lamp voltage feedback signal, i.e., the feedback signal is input to a lamp voltage regulation block to control the open lamp voltage, i.e., the ignition voltage. Under open lamp conditions, the augmentation of the switching frequency can be conducive to the generation of a higher ignition voltage to reignite a faulty or aged lamp.

FIG. 15 illustrates a block diagram of a protection circuit according to embodiments of the present disclosure. In the illustrated embodiment, a positive logic fault signal and a negative logic fault signal are used in combination for fault protection control. For example, a first protection circuit unit for processing a negative logic fault signal and a second protection circuit unit for processing a positive logic fault signal are coupled in parallel to a fault control block that includes a fault timer, a frequency sweep high block, and a pulse dimming invalidation block. The first protection circuit unit coupled to the fault control block functions similarly to the protection circuit 100 shown in FIG. 5, and the second protection circuit unit coupled to the fault control block functions similarly to the protection circuit 200 shown in FIG. 11. A first trigger signal and a second trigger signal are generated respectively by the first protection circuit unit and the second protection circuit unit to control the fault control block. When the first and/or the second trigger signal satisfies selected fault conditions, the fault control block is triggered to function.

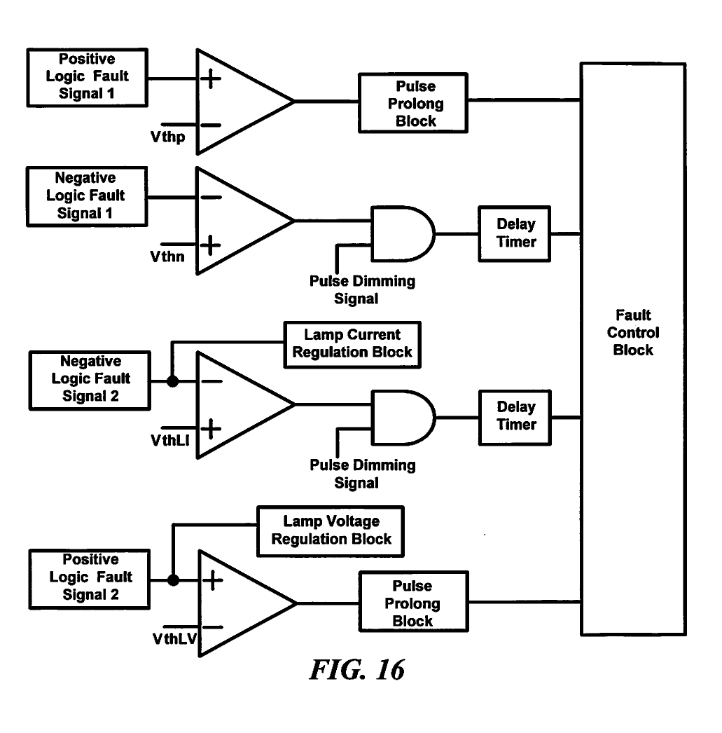

FIG. 16 illustrates a block diagram of a protection circuit according to additional embodiments of the present disclosure. In these embodiments, both a positive logic fault signal and a negative logic fault signal are used for fault protection control as well as for current and voltage regulation.

From the foregoing, it will be appreciated that specific embodiments of the disclosure have been described herein for purposes of illustration, but that various modifications may be made without deviating from the disclosure. Certain aspects of the disclosure described in the context of particular embodiments may be combined or eliminated in other embodiments. Not all embodiments need necessarily exhibit such advantages to fall within the scope of the disclosure. Accordingly, the disclosure is not limited except as by the appended claims.

I/We claim:

1. A fault protection method for a CCFL driving system, comprising:
detecting a fault signal;
comparing the fault signal with its corresponding threshold voltage to obtain a comparison signal; and
processing the comparison signal to generate a trigger signal and triggering a fault control block when the trigger signal satisfies certain fault conditions.

2. The fault protection method of claim 1, wherein the fault signal is a negative logic fault signal.

3. The fault protection method of claim 2, wherein processing the comparison signal includes:
processing the comparison signal and a pulse dimming signal through an “AND” gate to provide a control signal; and
inputting the control signal into a delay timer to obtain the trigger signal.

4. The fault protection method of claim 2, wherein the negative logic fault signal is a minimum lamp voltage.

5. The fault protection method of claim 2, wherein the negative logic fault signal is compared with the threshold voltage through a comparator such that when the negative logic fault signal is higher than the threshold voltage, the comparison signal is low, and when the negative logic fault signal is lower than the threshold voltage, the comparison signal is high.

6. The fault protection method of claim 3, wherein the delay timer has a predetermined threshold, and if the pulse width of the control signal is smaller than the predetermined threshold of the delay timer, the trigger signal is low, and if the pulse width of the control signal is larger than a predetermined threshold of the delay timer, the trigger signal is high.

7. The fault protection method of claim 6, wherein when the trigger signal is high, the fault control block is triggered, when the trigger signal is low, the fault control block is not triggered.

8. The fault protection method of claim 1, wherein when the fault control block is triggered, a fault timer is triggered to start timing and a switching frequency is swept to a higher value and the pulse dimming signal is invalidated.

9. The fault protection method of claim 8, wherein the invalidation of the pulse dimming signal includes forcing the pulse dimming signal to be high.

10. The fault protection method of claim 8, wherein the fault timer has a predetermined threshold, and when the timing of the fault timer exceeds the predetermined threshold, the method includes shutting down the CCFL driving system.

11. The fault protection method of claim 2, wherein the negative logic fault signal is a minimum lamp current.

12. The fault protection method of claim 2 wherein the negative logic fault signal is a mean lamp current, which is also used as a lamp current regulation signal.

13. The fault protection method of claim 1, wherein the fault signal is a positive logic fault signal.

14. The fault protection method of claim 13, wherein processing the comparison signal to generate the trigger signal includes prolonging a pulse period of the comparison signal.

15. The fault protection method of claim 13, wherein the positive logic fault signal is a maximum lamp voltage difference.

16. The fault protection method of claim 13, wherein the positive logic fault signal is compared with a threshold voltage through a comparator such that when the positive logic fault signal is lower than the threshold voltage, the comparison signal is low, and when the positive logic fault signal is higher than the threshold voltage, the comparison signal is high.

17. The fault protection method of claim 14, wherein when the trigger signal is high, the fault control block is triggered, when the trigger signal is low, the fault control block is not triggered.

18. The fault protection method of claim 13, wherein the positive logic fault signal is a maximum lamp current difference or a maximum lamp voltage also used as an open lamp voltage regulation signal.

19. The fault protection method of claim 1, wherein the fault signal includes a positive logic fault signal and a negative logic fault signal.

20. The fault protection method of claim 19, wherein
for the negative logic fault signal, processing the comparison signal includes:
processing the comparison signal and a pulse dimming signal through an “AND” gate to provide a control signal; and
inputting the control signal into a delay timer to obtain the trigger signal; and
for the positive logic fault signal, processing the comparison signal includes prolonging a pulse period of the comparison signal.

21. The fault protection method of claim 19, wherein the positive logic fault signal is a maximum lamp voltage difference, and wherein the negative logic fault signal is a minimum lamp voltage or a minimum lamp current.

22. The fault protection method of claim 19, wherein the positive logic fault signal is a maximum lamp current difference or a maximum lamp voltage, which is used as an open lamp voltage regulation signal, and wherein the negative logic fault signal is a mean lamp current, which is used as a lamp current regulation signal.

23. A fault protection circuit for a CCFL driving system, comprising:
a comparator configured to receive a negative logic fault signal, compare the negative logic fault signal with a corresponding threshold voltage to output a comparison signal;
an “AND” gate logic configured to receive the comparison signal and a pulse dimming signal to generate a control signal;
a delay timer configured to receive and process the control signal to generate a trigger signal; and
a fault control block configured to receive the trigger signal, and is triggered when the trigger signal satisfies a predetermined fault condition.

24. The fault protection circuit of claim 23, wherein when the negative logic fault signal is higher than the threshold voltage, the comparison signal is low, and wherein when the negative logic fault signal is lower than the threshold voltage, the comparison signal is high.

25. The fault protection circuit of claim 23, wherein the delay timer has a predetermined threshold, and if the pulse width of the control signal is smaller than the predetermined threshold of the delay timer, the trigger signal is low, and wherein if the pulse width of the control signal is larger than the predetermined threshold of the delay timer, the trigger signal is high.

26. The fault protection circuit of claim 23, wherein the fault control block comprises a fault timer, a pulse dimming invalidation block, and a frequency sweep high block.

27. The fault protection circuit of claim 26, wherein when the fault control block is triggered by the the trigger signal, the fault timer is triggered to start timing, the pulse dimming invalidation block invalidates the pulse dimming signal, and the frequency sweep high block starts to sweep the switching frequency to a higher value.

28. The fault protection circuit of claim 27, wherein the invalidation of the pulse dimming signal includes forcing the pulse dimming signal to high.

29. The fault protection circuit of claim 27, wherein the fault timer has a predetermined threshold, and when the timing of the fault timer exceeds the predetermined threshold of the fault timer, the method includes shutting down the CCFL driving system.

30. The fault protection circuit of claim 23, wherein the negative logic fault signal includes at least one of a mean lamp current, a minimum lamp current, and a minimum lamp voltage.

31. The fault protection circuit of claim 23, further comprising a lamp current regulation block, wherein the negative logic fault signal is a mean lamp current, which is input to the lamp current regulation block.

32. A fault protection circuit for a CCFL driving system, comprising:
a comparator configured to receive a positive logic fault signal and to compare the positive logic fault signal with a corresponding threshold voltage to output a comparison signal;
a pulse prolong block configured to receive the comparison signal and prolong the pulse period of the comparison signal to generate a trigger signal; and
a fault control block configured to receive the trigger signal, and is triggered when the trigger signal satisfies a predetermined fault condition.

33. The fault protection circuit of claim 32, wherein when the positive logic fault signal is lower than the threshold voltage, the comparison signal is low, and wherein when the positive logic fault signal is higher than the threshold voltage, the comparison signal is high.

34. The fault protection circuit of claim 32, wherein the fault control block comprises a fault timer, a pulse dimming invalidation block, and a frequency sweep high block.

35. The fault protection circuit of claim 34, wherein when the fault control block is triggered, the fault timer is triggered to start timing, the pulse dimming invalidation block invalidates the pulse dimming signal, and the frequency sweep high block starts to sweep the switching frequency to a higher value.

36. The fault protection circuit of claim 35, wherein the invalidation of the pulse dimming signal includes forcing the pulse dimming signal to be in high level or in low level.

37. The fault protection circuit of claim 35, wherein the fault timer has a predetermined threshold, and wherein when the timing of the fault timer exceeds the predetermined threshold, the method includes shutting down the CCFL driving system.

38. The fault protection circuit of claim 32, wherein the positive logic fault signal includes at least one of a maximum lamp voltage, a maximum lamp voltage difference, and a maximum lamp current difference.

39. The fault protection circuit of claim 32, further comprising a lamp voltage regulation block for controlling the open lamp voltage, wherein the positive logic fault signal is a maximum lamp voltage, which is input to the lamp voltage regulation block for regulating the open lamp voltage.

40. A fault protection circuit for CCFL driving system, comprising a fault control block, a first circuit unit and a second circuit unit coupled in parallel to the fault control block; wherein
the first circuit unit comprises:
a first comparator configured to receive a negative logic fault signal, comparing the negative logic fault signal with a first threshold voltage to output a first comparison signal;
an “AND” gate logic configured to receive the first comparison signal and a pulse dimming signal to generate a control signal; and
a delay timer configured to receive and processing the control signal to generate a first trigger signal; and
the second circuit unit comprises:
a second comparator configured to receive a positive logic fault signal, comparing the positive logic fault signal with a second threshold voltage to output a comparison signal;
a pulse prolong block configured to receive the comparison signal and prolong the pulse period of the comparison signal to generate a second trigger signal; and
the fault control block receives the first trigger signal and the second trigger signal, and when the first and/or the second trigger signal satisfies certain fault conditions, the fault control block is triggered.

41. The fault protection circuit of claim 40, wherein the fault control block comprises a fault timer, a pulse dimming invalidation block, and a frequency sweep high block.

42. The fault protection circuit of claim 40, wherein when the fault control block is triggered, the fault timer starts timing, the pulse dimming invalidation block invalidates the pulse dimming signal, and the frequency sweep high block starts to sweep the switching frequency to a higher value.

43. The fault protection circuit of claim 42, wherein the fault timer has a predetermined threshold, and when the timing of the fault timer exceeds the predetermined threshold of the fault timer, the method includes shutting down the CCFL driving system.

44. The fault protection circuit of claim 40, wherein the positive logic fault signal includes a maximum lamp voltage difference or a maximum lamp current difference; the negative logic fault signal includes a minimum lamp voltage or a minimum lamp current.

45. The fault protection circuit of claim 40, further comprising a lamp voltage regulation block for controlling the open lamp voltage, wherein the positive logic fault signal includes a maximum lamp voltage, which is input to the lamp voltage regulation block for regulating the open lamp voltage.

46. The fault protection circuit of claim 40, further comprising a lamp current regulation block, wherein the negative logic fault signal includes a mean lamp current, which is input to the lamp current regulation block.
